(19) United States
(12) Patent Application Publication
(10) Pub. No.: US 2015/0147253 A1
(43) Pub. Date: May 28, 2015

(54) WASHING SOLUTION FOR THE ABSORPTION OF CARBON DIOXIDE WITH REDUCED FORMATION OF NITROSAMINES

(71) Applicant: Siemens Aktiengesellschaft, Munich (DE)

(72) Inventors: Björn Fischer, Dusseldorf (DE); Ralph Joh, Seligenstadt (DE); Markus Kinzl, Dietzenbach (DE); Diego Andres Kuettel, Kassel (DE); Rüdiger Schneider, Eppstein (DE); Martin Wiese, Aachen (DE)

(73) Assignee: Siemens Aktiengesellschaft, Munich (DE)

(21) Appl. No.: 14/414,111

(22) PCT Filed: Jul. 8, 2013
(86) PCT No.: PCT/EP2013/064338

§ 371 Date: Jan. 11, 2015

(30) Foreign Application Priority Data
Jul. 17, 2012 (DE) 10 2012 212 484.5

(51) Int. Cl. B01D 53/96; B01D 53/62; B01D 53/14

(52) U.S. Cl. CPC B01D 53/96; B01D 53/1493; B01D 53/62; B01D 2252/204; B01D 2251/30; B01D 2257/504
USPC 423/228; 252/186.1

(57) ABSTRACT

A washing solution for the absorption of carbon dioxide is provided. A method for separating carbon dioxide out of a flue gas of an incineration plant is also provided, wherein at least one alkali metal oxide is added as an oxidation agent for nitrites to a washing solution having an amine-containing absorption agent, the flue gas is brought into contact with the washing solution prepared in this manner and the contained carbon dioxide is absorbed, and wherein the washing solution is then heat-treated and the carbon dioxide is desorbed. A corresponding washing solution having an amine-containing absorption agent and having at least one alkali metal oxide as an oxidation agent for nitrites is also provided.

### CROSS REFERENCE TO RELATED APPLICATIONS

This application is the US National Stage of International Application No. PCT/EP2013/064338 filed Jul. 8, 2013, and claims the benefit thereof. The International Application claims the benefit of German Application No. DE 102012212484.5 filed Jul. 17, 2012. All of the applications are incorporated by reference herein in their entirety.

### FIELD OF INVENTION

The invention relates to a scrubbing solution for the absorption of carbon dioxide from a flue gas from a combustion plant. The invention further relates to a process for separating off carbon dioxide from a flue gas from a combustion plant by means of such a scrubbing solution.

### BACKGROUND OF INVENTION

In the combustion of a fossil fuel in a combustion plant, for example in a fossil fuel-fired power station for the generation of electric energy, the flue gas formed is loaded to a not inconsiderable extent with carbon dioxide. Apart from carbon dioxide, such a flue gas contains further combustion products, for example the gases nitrogen, sulfur oxides, nitrogen oxides and water vapor and also solid particles, dusts and soot. The flue gas is usually discharged into the atmosphere after substantial removal of the solid constituents. Nitrogen oxides and/or sulfur oxides may also be separated off catalytically or wet-chemically. However, as a natural constituent of the earth's atmosphere, carbon dioxide is usually discharged into the atmosphere.

However, the increase in the proportion of carbon dioxide in the earth's atmosphere caused by human beings is held responsible as main cause of the increase in the surface temperatures of the earth, referred to as climate change. This is because carbon dioxide present in the atmosphere hinders radiation of heat from the earth's surface into space, generally known as the greenhouse effect.

For this reason, secondary measures involving removal of the carbon dioxide formed from the flue gas after combustion are being discussed for existing power stations. One technical possibility here is to bring the flue gas into contact with a scrubbing solution admixed with a suitable absorbent for carbon dioxide. The most promising absorbents at present appear to be amine-containing absorbents, with alkanolamines in particular but also more complex sterically hindered amines having large alkyl groups, cyclic amines, amino acids or amino acid salts being used as amines. The amines used either react with carbon dioxide to form carbamates or the carbon dioxide reacts in the scrubbing solution indirectly to form hydrogencarbonate and a protonated amine.

Contact of the flue gas with the scrubbing solution results in gaseous carbon dioxide present being dissolved or chemically absorbed in the scrubbing solution. The flue gas which has been freed of carbon dioxide is discharged into the atmosphere. The scrubbing solution loaded with carbon dioxide can be brought to another place where it is regenerated again by means of a thermal treatment with desorption of carbon dioxide. The carbon dioxide which has been separated off can then, for example, be compressed, cooled and liquefied in a plurality of stages. In the liquid or frozen state, the carbon dioxide can then be passed to storage or a use. The regenerated scrubbing solution is reused for the absorption of carbon dioxide from the flue gas.

The abovementioned nitrogen oxides are also undesirably introduced into the absorption process via the flue gas. Depending on pressure and temperature, nitrogen dioxide and nitrogen monoxide in particular are in equilibrium. Here, nitrogen dioxide radicals can react with water and form nitrites:

2 NO₂+2 H₂O->2 NO₂⁻+2 OH⁻.

The nitrites formed react with the amines of the absorbent during the process to form nitrosamines (N-nitroso compounds) which is disadvantageous because the latter are suspected of being carcinogenic. The nitrosamines formed can have a low vapor pressure so that they can be discharged together with the purified flue gas into the atmosphere. For this reason, nitrosamines are prominent in current discussions with regard to power stations having low carbon dioxide emissions.

This problem does not occur in gas scrubs in the chemical industry since the nitrosating substance (nitrogen dioxide, nitrogen monoxide) is generally not present. In some processes, e.g. in the tire industry, inhibitors are deliberately added to the process in order to prevent formation of the N-nitroso components. In the food industry, there are a few known inhibitors, e.g. selenium. However, the acidic medium present there differs significantly from the alkaline conditions in the removal of carbon dioxide from a flue gas. In the carbon dioxide removal process, these inhibitors would, if they are active at all under the given conditions, have to be used in large amounts in order to compete with the amine which is present in high concentration. The large burden of inactive substances in the process circuit is extremely disadvantageous since these have to be additionally pumped around, as a result of which the efficiency of the power station is reduced further.

### SUMMARY OF INVENTION

It is therefore an object of the invention to provide a scrubbing solution of the type mentioned at the outset and also a process for separating off carbon dioxide from the flue gas from a combustion plant, by means of which a very low concentration of nitrosamines in the flue gas which has been freed of carbon dioxide can be achieved.

As regards the scrubbing solution for the absorption of carbon dioxide from a flue gas from a combustion plant, the object is achieved according to the invention by at least one alkali metal oxide being added as oxidant for nitrites to the scrubbing solution in addition to an amine-containing absorbent.

The invention proceeds from the idea of promoting the reaction path of the nitrites to nitrates which no longer react further in the process but instead together with the metals introduced by the flue gas form stable salts. This is achieved by the addition of alkali metal oxides which are able to react with metallic nitrite salts, in particular those of alkali metals, with heating to form metallic nitrate salts. Cations of various metals and in particular of alkali metals are, for example, introduced into the scrubbing solution from the flue gas during the process. Metallic cations, in particular of alkali metals, can also be present in the scrubbing solution, for example when using amino acid salts.

The reaction path of the nitrites to nitrates is accordingly promoted by the addition of alkali metal oxides to the scrubbing solution, so that the proportion of nitrosamines in the offgas from the carbon dioxide removal is reduced.

In an advantageous embodiment of the scrubbing solution, the at least one alkali metal oxide is selected from the group consisting of lithium, sodium and potassium oxide. These form, in particular, oxides of the M₂O type. A plurality of alkali metal oxides can also advantageously be comprised.

In a further advantageous variant, the total proportion of alkali metal oxides is at least of the order of magnitude of the nitrites formed by introduction of flue gas. As a result, an economically relevant reduction in nitrosamine formation takes place.

The scrubbing solution is advantageously present as an aqueous solution. The use of water has become established because of the position of its boiling point and also for ecological aspects and not least for cost reasons.

The amine-containing scrubbing medium can in principle contain a single amine or a mixture of amines. As amines, it is possible to use primary amines such as monoethanolamine or diglycolamine, secondary amines such as diethanolamine or diisopropanolamine and tertiary amines such as methyldiethanolamines.

It is likewise possible to use complex amines such as amines which are sterically hindered for carbamate formation or cyclic amines. In the case of a sterically hindered amine, carbamate formation is, for example, hindered by a large alkyl group on the amino group, as is the case for, for example, 2-amino-2-methyl-1-propanol. Examples of cyclic amines are piperazine and its derivatives. Once again, it is possible to use a single amino acid salt such as a potassium salt of glycine or other amino acids. Mixtures of various amino acid salts can also be used as absorbents. The great advantage of the present invention is particularly apparent when using secondary amines since the nitrosamines formed from secondary amines are especially stable over time. The primary nitrosamines react further to form alkenes and alcohols, which are of significantly less concern than the carcinogenic nitrosamines.

As regards an amino acid salt, it has been found to be advantageous to use an amino acid salt which has a carbon substituent from the group consisting of hydrogen, an alkyl, a hydroxyalkyl and an aminoalkyl. Further advantages are given to using an amino acid salt which has a nitrogen substituent from the group consisting of hydrogen, an alkyl, a hydroxyalkyl and a haloalkyl.

In a further embodiment, the amino acid salt is a salt of a metal, in particular an alkali metal. The cations of the alkali metals used which are present in the scrubbing solution as a result likewise lead, in combination with the alkali metal oxides added, to promotion of the reaction path of the nitrites to nitrates according to the above equation.

The object with regard to a process for separating off carbon dioxide from a flue gas from a combustion plant is achieved according to the invention by at least one alkali metal oxide being added as oxidant for nitrites to a scrubbing solution comprising an amine-containing absorbent, the flue gas subsequently being brought into contact with the scrubbing solution which has been treated in this way with absorption of carbon dioxide present and the scrubbing solution subsequently being thermally treated with desorption of the carbon dioxide.

Advantageously, the above-described scrubbing solution is used for the process or such a scrubbing solution is treated. The advantages mentioned for the dependent claims for the scrubbing solution can analogously be applied to the process for the removal of carbon dioxide.

The addition of a metal oxide is advantageously carried out continuously in accordance with the order of magnitude of the nitrites formed, i.e., for example, based on the volume of the treated flue gas in standard cubic meters. The amount of oxidant in the scrubbing solution therefore corresponds essentially to the order of magnitude of the introduction of NO₂ by the flue gas.

### BRIEF DESCRIPTION OF THE DRAWINGS

Working examples of the invention are illustrated, in more detail with the aid of a drawing. The figures show:

FIG. 1 a schematic depiction of an apparatus for separating off carbon dioxide from the flue gas from a combustion plant,

FIG. 2 a general structural formula for an amino acid salt.

### DETAILED DESCRIPTION OF INVENTION

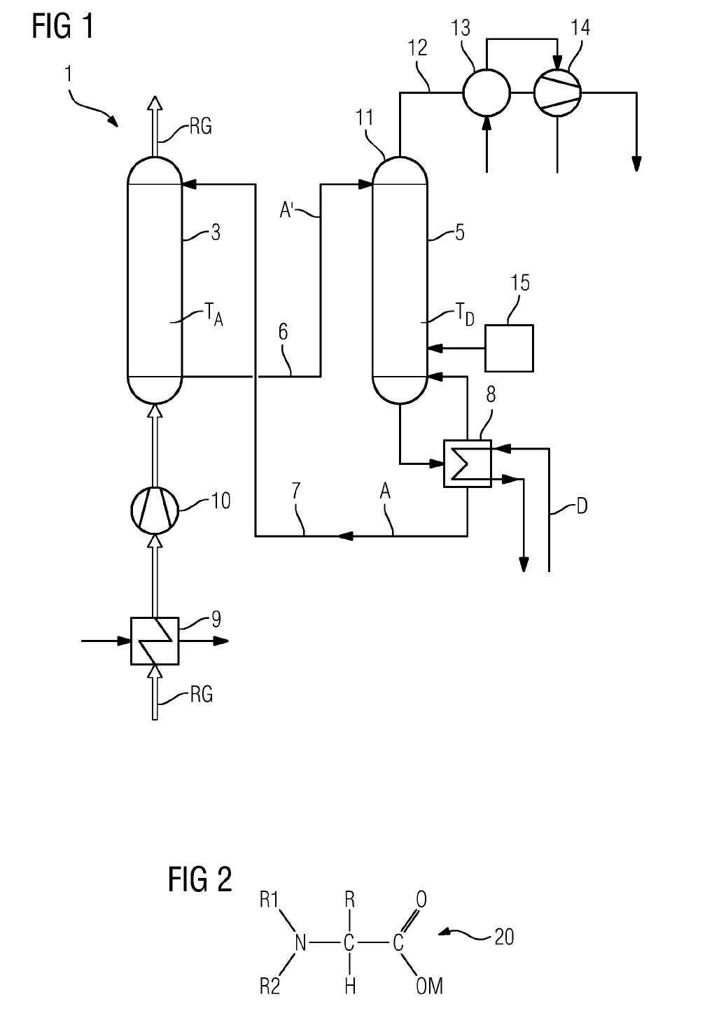

FIG. 1 schematically shows a removal apparatus 1 for separating off carbon dioxide from a flue gas from a combustion plant. The removal apparatus 1 comprises an absorption facility 3 and a desorption facility 5 between which a loaded scrubbing solution A′ and a regenerated scrubbing solution A circulate in the lines 6, 7. A scrubbing solution A′ loaded with carbon dioxide from the absorption facility 3 is conveyed via line 6 into the desorption facility 5 for regeneration.

Regenerated scrubbing solution A from the desorption facility 5 is conveyed via line 7 back into the absorption facility 3.

The desorption facility 5 is assigned a reboiler 8 through which a process vapor D from a combustion plant is conveyed during operation for introduction of heat. This heat is introduced by recirculation of the scrubbing solution A into the desorption facility 5 so that scrubbing solution A present therein is heated to a desorption temperature T_{D}, resulting in thermal desorption of dissolved carbon dioxide.

To separate off carbon dioxide, the flue gas RG from the combustion plant is, during operation, firstly cooled in a flue gas cooler 9 and subsequently sent via a transport line 10 to the absorption facility 3. There, the cool flue gas RG is brought into countercurrent contact with regenerated scrubbing solution A, so that carbon dioxide present is absorbed or dissolved. At an absorption temperature T_{A}, the amine-containing scrubbing solution A has a high loading capacity for carbon dioxide. The flue gas RG which has been freed of carbon dioxide is discharged into the atmosphere.

The scrubbing solution A′ loaded with carbon dioxide flows into the desorption facility 5 for regeneration. In the upper region of the desorption facility 5, carbon dioxide-rich gas is discharged via a gas line 12 and conveyed via a heat exchanger 13 and a subsequent compressor 14. Gaseous carbon dioxide in the stream is compressed in the compressor 14 and used for further purposes, for example injected into an aquifer or stored in another carbon dioxide store.

The removal apparatus 1 shown is particularly suitable for use in a steam power station, in a gas turbine plant or in a combined gas and steam turbine plant, in particular with integrated gasification of coal, for separating off carbon dioxide from the flue gas.

In particular, the removal apparatus 1 is useful for modernization or retrofitting of such a power station.

The scrubbing solution A used contains an amine or a mixture of a plurality of amines. The scrubbing solution advantageously contains an amino acid salt or a plurality of amino acid salts. In addition, an alkali metal oxide of the M₂O type, in particular a sodium oxide, is added to the scrubbing solution as oxidant for nitrites. The oxidant is introduced continuously in the same order of magnitude as NO₂ is introduced via the treated flue gas. In this way, the reaction path of oxidation of nitrites to nitrates is promoted, so that a smaller amount of nitrites is available for the undesirable reaction of the nitrites to form nitrosamines. A smaller amount of nitrosamines is thus formed in the removal process. The concentration of nitrosamines in the offgas which has been freed of carbon dioxide is reduced. In addition, less absorbent is also withdrawn from the removal process as a result of reduced formation of nitrosamines. The amount of absorbent required is reduced thereby, so that the total operating costs for the removal apparatus 1 are also reduced thereby.

FIG. 2 shows the general structural formula of an amino acid salt 20 which, in one embodiment, is used as absorbent in the scrubbing solution A of the removal apparatus 1. The scrubbing solution A is introduced here as an aqueous solution.

The amino acid salt 20 has a carbon substituent R and further nitrogen substituents R1 and R2. The carbon substituent R is a compound from the group consisting of hydrogen, alkyl, hydroxyalkyl and aminoalkyl. The further nitrogen substituents R1, R2 are selected from the group consisting of hydrogen, alkyl, hydroxyalkyl and haloalkyl. The amino acid salt 20 is a salt of a metal M, in particular a salt of an alkali metal, for example potassium or sodium, with a proton in the carboxy group being replaced by the metal M in ionic form.

After carbon dioxide has been separated off by means of the above-described scrubbing solution, the scrubbing solution used in the process with addition of alkali metal oxides has higher nitrate values than without alkali metal oxides. The oxidation of nitrites to nitrates is thus promoted. A smaller amount of nitrosamines is formed.

1.-13. (canceled)

14. A scrubbing solution for the absorption of carbon dioxide from a flue gas from a combustion plant, comprising:
at least one amine-containing absorbent, and
at least one alkali metal oxide as an oxidant for nitrites.

15. The scrubbing solution as claimed in claim 14,
wherein the at least one alkali metal oxide is selected from the group consisting of lithium oxide, sodium oxide and potassium oxide.

16. The scrubbing solution as claimed in claim 14, comprising
a plurality of alkali metal oxides.

17. The scrubbing solution as claimed in claim 14,
wherein the total proportion of alkali metal oxides corresponds to the order of magnitude of nitrites formed.

18. The scrubbing solution as claimed in claim 14,
wherein the scrubbing solution is present as aqueous solution.

19. The scrubbing solution as claimed in claim 14, comprising
a plurality of amines.

20. The scrubbing solution as claimed in claim 14,
wherein an alkanolamine and/or an amine which is sterically hindered for the formation of carbamate is present as amine.

21. The scrubbing solution as claimed in claim 14,
wherein an amino acid salt is present as amine.

22. The scrubbing solution as claimed in claim 21,
wherein the amino acid salt has a carbon substituent from the group consisting of hydrogen, an alkyl, a hydroxyalkyl and an aminoalkyl.

23. The scrubbing solution as claimed in claim 21,
wherein the amino acid salt has a nitrogen substituent from the group consisting of hydrogen, an alkyl, a hydroxyalkyl and a haloalkyl.

24. The scrubbing solution as claimed in claim 21,
wherein the amino acid salt is a salt of a metal.

25. A process for separating off carbon dioxide from a flue gas from a combustion plant, comprising:
adding at least one alkali metal oxide as oxidant for nitrites to a scrubbing solution comprising an amine-containing absorbent,
bringing the flue gas into contact with the scrubbing solution resulting in absorption of carbon dioxide present, and
subsequently thermally treating the scrubbing solution with desorption of the carbon dioxide.

26. The process as claimed in claim 25,
wherein a scrubbing solution comprising at least one amine-containing absorbent, and at least one alkali metal oxide as an oxidant for nitrites is treated.

27. The scrubbing solution as claimed in claim 24,
wherein the amino acid salt is a salt of an alkali metal.
